(19) United States
(12) Patent Application Publication
(10) Pub. No.: US 2025/0346733 A1
(43) Pub. Date: Nov. 13, 2025

(54) IMPROVED METHOD FOR PROCESSING LIQUEFIED WASTE PLASTICS

(71) Applicant: Neste Oyj, Espoo (FI)

(72) Inventors: Ville PAASIKALLIO, Porvoo (FI); Min WANG, Porvoo (FI); Antti PASANEN, Porvoo (FI); Inkeri KAUPPI, Porvoo (FI)

(73) Assignee: Neste Oyj, Espoo (FI)

(21) Appl. No.: 18/993,445

(22) PCT Filed: Jul. 4, 2023
(86) PCT No.: PCT/FI2023/050428

§ 371 Date: Jan. 10, 2025

(30) Foreign Application Priority Data
Jul. 12, 2022 (EP) 22184301.4
Jul. 12, 2022 (FI) 20225658

(51) Int. Cl. C08J 11/08

(52) U.S. Cl. CPC C08J 11/08; C08J 2387/00

(57) ABSTRACT

An improved method for processing liquefied waste plastics includes providing a liquefied waste plastic (LWP) feedstock for heat treatment (HT processing) with an aqueous solution containing a basic substance, subjecting the LWP feedstock to the heat treatment with the aqueous solution, followed by phase separation to result in at least a treated LWP material and an aqueous phase, determining the quality of the LWP feedstock by measuring at least one property of the LWP feedstock, the at least one property including at least the total acid number (TAN) of the LWP feedstock, and calculating an amount of the basic substance to be added in HT processing to reach a target pH level of the aqueous phase based on the at least one property of the LWP feedstock and the water-oil-ratio, and adding the calculated amount of basic.

### Technical Field

The present invention relates to an improved method for processing liquefied waste plastics, more particularly to improvements in purification efficiency and process efficiency of a purification process of (crude) liquefied waste plastics.

### BACKGROUND OF THE INVENTION

The purification of liquefied waste plastics (LWP) to yield more valuable (pure) substances and the conversion of liquefied waste plastics (LWP) into more valuable material have been studied for several years.

LWP is typically produced by pyrolysis or hydrothermal liquefaction (HTL) of waste plastics. Depending on the source of the waste plastics, LWP has variable levels of impurities. Typical impurity components are chlorine, nitrogen, sulphur and oxygen of which corrosive chlorine is particularly problematic for refinery/petrochemical processes. These impurities originate from the waste plastic material, such as post-consumer waste plastics (recycled consumer plastics), which have been identified as the most potential large-scale source for plastics waste. Similarly, bromine-containing impurities may be contained mainly in industry-derived waste plastics (e.g. originating from flame retardants).

No matter whether the LWP is merely subjected to common refinery processing (e.g. fractionation) or is forwarded to a typical petrochemical conversion process (e.g. steam cracking), the LWP feed needs to meet the impurity levels for these processes so as to avoid deterioration of the facility, such as corrosion of reactors or catalyst poisoning.

In addition to refining, chemical recycling of LWP back to plastic (or to monomers) is an interesting option which has sparked significant interest in the petrochemical industry during the last years. The attention has been further boosted by a new waste directive and the EU plastic strategy that both set ambitious targets for the recycling of waste plastics.

In view of the increasing interest in adding LWP to the value chain, several options for purifying LWP so as to make it more suitable for conventional oil refinery processing have been developed.

WO 2018/10443 A1 discloses a steam cracking process comprising pre-treatment of a mainly paraffinic hydrocarbon feed, such as hydrowax, hydrotreated vacuum gas oil, pyrolysis oil from waste plastics, gasoil or slackwax. Pre-treatment is carried out using a solvent extraction so as to reduce fouling components, such as polycyclic aromatics and resins. Such solvent extraction techniques may have poor removal efficiency for certain contaminants in the LWP and furthermore result in significant amounts of contaminated extraction material, which requires workup or disposal.

US 2016/0264874 A1 discloses a process for upgrading waste plastics, comprising a pyrolysis step, a hydroprocessing step, a polishing step and a steam cracking step in this order. This process consumes large amounts of hydrogen, which is usually produced from fossil sources. The process is thus not favourable in view of sustainability.

FI 128848 B discloses a process for converting LWP into a steam cracker feed by heat treating the LWP with an aqueous medium having a pH of at least 7, followed by hydrotreatment of the treated LWP. Purification using an aqueous medium results in large amounts of contaminated water. The contaminated water has a high content of organic contaminants and thus needs to be further treated (e.g. purified) before it can be forwarded to a conventional waste water treatment. Purification may be accomplished by several routes.

US 2014/0303421 A1 discloses a method for conditioning synthetic crude oils with a caustic process solution. US 2014/0303421 A1 employs slightly elevated temperature together with a caustic solution having a pH of about 8 to 10. The conditioning treatment of US 2014/0303421 A1 is a washing treatment and does not qualify as a HT processing of the present invention.

FI 128069 B relates to a method of purifying e.g. recycled material, such as LWP, comprising a purification step and a hydrotreatment step, wherein the purification step may be carried out in the presence of an aqueous solution of alkaline metal hydroxide. This procedure achieves good removal efficiency of chlorine impurities but still results in large amounts of waste water.

### SUMMARY OF INVENTION

The above prior art approaches employ various purification procedures for LWP, each having certain drawbacks regarding efficiency, in particular regarding purification efficiency, efficient use of chemicals and handling of contaminated water (waste water).

The present invention was made in view of the above-mentioned problems and it is an object of the present invention to provide an improvement in the process of upgrading LWP, in particular an improvement of the purification efficiency usage amount of aqueous solution and a basic substance contained therein in a heat treatment process for purifying a LWP feedstock. More specifically, the present invention aims at optimizing the amount of a basic substance in an aqueous solution employed relative to a LWP feedstock amount as well as its impurities content so to improve the efficiency of the impurity removals from LWP, especially from LWP with high acidity.

This problem of providing an improved process for upgrading LWP is solved by a method set forth in any one of the claims.

In brief, the present invention relates to one or more of the following items:

1. A method, comprising:
providing a liquefied waste plastic (LWP) feedstock for heat treatment (HT processing) with an aqueous solution containing a basic substance,
subjecting the LWP feedstock to the heat treatment with the aqueous solution, followed by phase separation to result in at least a treated LWP material and an aqueous phase,
characterized in that the method comprises
determining the quality of the LWP feedstock by measuring at least one property of the LWP feedstock, the at least one property including at least the total acid number (TAN) of the LWP feedstock, and
calculating an amount of the basic substance that needs to be added in HT processing to reach a target pH level of the aqueous phase based on the at least one property of the LWP feedstock and the water-oil-ratio, and adding the calculated amount of basic substance in the form of aqueous solution to be in contact with the LWP feedstock.

2. The method according to item 1, wherein the method further comprises monitoring the pH level of the aqueous phase obtained from phase separation.

3. The method according to item 1 or 2, wherein the method further comprises a step of repeatedly readjusting the amount of the basic substance in the form of the aqueous solution to reach the target pH level of the aqueous phase.

4. The method according to any one of the preceding items, wherein the target pH level is pH 10.0 or more, preferably in the range of from 10.2 to 13.9, 10.3 to 13.8, 10.4 to 13.6, 10.5 to 13.5, 10.6 to 13.4, 10.7 to 13.3, 10.8 to 13.2, 10.9 to 13.1, or 11.0 to 13.0.

5. The method according to any one of the preceding items, wherein the at least one property of the LWP feedstock includes both the total acid number (TAN) and the total chlorine content of the LWP feedstock.

6. The method according to any one of the preceding items, further comprising measuring the alkalinity of the aqueous phase by titration and using the result of the measurement of the alkalinity as a basis for readjusting the amount of the basic substance.

7. The method according to any one of the preceding items, wherein the amount of the basic substance is adjusted and/or readjusted by modifying the concentration of the basic substance in the aqueous solution employed in HT processing.

8. The method according to any one of the preceding items, wherein the LWP feedstock has a total acid number (TAN) in the range of 0.1 to 100.0 mgKOH/g, such as 0.2 to 95.0 mgKOH/g, 0.3 to 90 mg KOH/g or more; 1.0 to 80 mg KOH/g, 3.0 to 60 mg KOH/g, 5.0 to 50.0 mg KOH/g, 7.0 to 30.0 mg KOH/g, or 9.0 to 20.0 mg KOH/g.

9. The method according to any one of the preceding items, wherein the LWP feedstock is crude liquefied waste plastics or a fraction thereof.

10 10. The method according to any one of the preceding items, wherein the LWP feedstock has an initial boiling point of 50° C. or less, such as an initial boiling point in the range of 15° C. to 50° C., 20° C. to 45° C., or 25° C. to 40° C.

11. The method according to any one of the preceding items, wherein the LWP feedstock has a final boiling point of 400° C. or more, such as in the range of from 400° C. to 700° C., 450° C. to 650° C., 500°° C. to 650° C., or 550° C. to 650° C.

12. The method according to any one of the preceding items, wherein the basic substance is selected from the group consisting of alkali metal hydroxides and alkaline earth metal hydroxides.

13. The method according to any one of the preceding items, wherein the basic substance is selected from the group consisting of KOH, NaOH, LiOH, Ca(OH)₂, Mg(OH)₂, RbOH, Sr(OH)₂and Ba(OH)₂.

14. The method according to any one of the preceding items, wherein the basic substance is NaOH.

15. The method according to any one of the preceding items, wherein the LWP feedstock has an olefins content of 5 wt.-% or more, such as 10 wt.-% or more, 15 wt.-% or more, 20 wt.-% or more, 30 wt.-% or more, 40 wt.-% or more, or 50 wt.-% or more.

16. The method according to any one of the preceding items, wherein the LWP feedstock has an olefins content of 85 wt.-% or less, such as 80 wt.-% or less, 70 wt.-% or less, or 65 wt.-% or less.

17. The method according to any one of the preceding items, wherein the aqueous solution comprises at least 50 wt.-% water, preferably at least 70 wt.-% water, more preferably at least 85 wt.-% water, at least 90 wt.-% water or at least 95 wt.-% water.

18. The method according to any one of the preceding items, wherein the aqueous solution comprises at least 0.3 wt.-% of the basic substance, more preferably at least 0.5 wt.-%, at least 1.0 wt.-%, or at least 1.5 wt.-% of the basic substance, such as 0.5 wt.-% to 10.0 wt.-%, 1.0 wt.-% to 6.0 wt.-%, or 1.5 w.-% to 4.0 wt.-%. 19. The method according to any one of the preceding items, wherein the aqueous solution comprises at least 0.5 wt.-%, preferably at least 1.0 wt.-%, or at least 1.5 wt.-% of a metal hydroxide or of an alkali metal hydroxide, such as from 0.5 wt.-% to 10.0 wt.-%, 1.0 wt.-% to 6.0 wt.-%, or 1.5 w.-% to 4.0 wt.-%. 20. The method according to any one of the preceding items, wherein the HT processing is carried out at a temperature of 150° C. or more, preferably 190° C. or more.

21. The method according to any one of the preceding items, wherein HT processing is carried out at a temperature of 200° C. or more, such as 210° C. or more, 220° C. or more, 240° C. or more or 260° C. or more.

22. The method according to any one of the preceding items, wherein the HT processing is carried out at a temperature of 450° C. or less, preferably 400° C. or less, 350° C. or less, 320° C. or less, or 300° C. or less.

23. The method according to any one of the preceding items, wherein the HT processing is carried out at a temperature in the range of 200° C. to 350° C., preferably 220° C. to 330° C., 240° C. to 320° C., or 260° C. to 300° C.

24. The method according to any one of the preceding items, wherein the chlorine content of the LWP feedstock is in the range of from 1 wt.-ppm to 4000 wt.-ppm, such as 100 wt.-ppm to 4000 wt.-ppm, or 300 wt.-ppm to 4000 wt.-ppm.

25. The method according to any one of the preceding items, wherein the LWP feedstock is a fraction of liquefied waste plastics.

26. The method according to any one of the preceding items, wherein the liquefied waste plastics (LWP) feedstock has a 5% boiling point of 25° C. or more, preferably 30° C. or more, or 35° C. or more, such as in the range of from 25° C. to 120° C., in the range of from 25° C. to 100° C., in the range of 30° C. to 90° C., or in the range of from 35° C. to 80° C.

27. The method according to any one of the preceding items, wherein the liquefied waste plastics (LWP) feedstock has a 95% boiling point of 700° C. or less, preferably 650° C. or less, 600° C. or less, or 550° C. or less, such as in the range of from 180° C. to 700° C., 250° C. to 700° C., 300° C. to 650° C., 350° C. to 600° C., 380° C. to 500° C., or 400° C. to 500° C.

28. The method according to any one of the preceding items, wherein the step of providing the LWP feedstock includes a step of liquefying waste plastics, preferably by thermal degradation of waste plastics, such as pyrolysis or hydrothermal liquefaction or similar process steps.

29. The method according to any one of the preceding items, wherein the step of providing the LWP feedstock includes a step of liquefying sorted waste plastics, and the method further comprises a step of sorting waste plastics to provide sorted waste plastics, preferably removing at least 50 wt.-%, more preferably at least 55 wt.-%, at least 60 wt.-%, at least 65 wt.-%, at least 70 wt.-%, at least 75 wt.-%, at least 80 wt.-%, or at least 85 wt.-% of chlorine-containing waste plastics, such as polyvinyl chloride, PVC (relative to the original content of chlorine-containing waste plastic, such as PVC, in the waste plastics).

30. The method according to any one of the preceding items, wherein no hydrogen is added in the HT processing and/or no hydrotreating catalyst is present.

31. The method according to any one of the preceding items, wherein the ratio between the bromine number (BN2) of the treated LWP material and the bromine number (BN1) of the LWP feedstock, BN2/BN1 is 0.90 or more, preferably 0.95 or more, such as in the range of from 0.90 to 1.10, 0.90 to 1.02 or 0.95 to 1.00.

32. The method according to any one of the preceding items, wherein the LWP feedstock has a density, as measured at 15° C. in the range of from 0.780 to 0.950 kg/l, such as in the range of from 0.780 to 0.900 kg/l, or in the range of from 0.780 to 0.850 kg/l.

33. The method according to any one of the preceding items, wherein mixing ratio (water-oil-ratio) between the aqueous solution and the LWP feedstock in the heat treatment step is in the range of from 0.1 to 1.4 by weight, preferably in the range of 0.2 to 1.0, such as 0.2 to 0.7.

### DETAILED DESCRIPTION OF THE INVENTION

The present invention relates to an improvement in the method for upgrading liquefied waste plastics.

An LWP feed, such as a pyrolysis product of collected consumer plastics, contains large and varying amounts of contaminants which would be detrimental in downstream processes. Such contaminants include, among others, halogens (mainly chlorine) originating from halogenated plastics (such as PVC and PTFE), sulphur originating from cross-linking agents of rubbery polymers (e.g. in end-of-life tires) and metal (e.g. Si, Al) contaminants originating from composite materials and additives (e.g. films coated with metals or metal compounds, end-of-life tires, or plastics processing aids). These contaminants may be present in elemental form, in ionic form, or as a part of organic or inorganic compounds.

These impurities should be removed before the LWP is subjected to further processing. The present invention focusses on a method of removing such impurities (or contaminants) by treatment of an LWP feedstock with an aqueous solution comprising a basic substance (also referred to as alkaline aqueous solution) at elevated temperature (also referred to as HT processing). HT processing may also be referred to as “reactive extraction”. The HT processing results in large amounts of waste water (emerging from the aqueous phase obtained from phase separation). The present invention provides an improvement of the HT process of an LWP feedstock, especially an LWP feedstock with high acidity, and workup which enables more efficient use of a basic substance as well as improved purification efficiency.

The present invention specifically focuses on a case of LWP feedstock containing certain amounts of acidic substances other than halogen compounds. That is, even in a theoretical case of an LWP feedstock containing an extremely high content of 2000 wt.-ppm chlorine (elemental content, organic plus inorganic) which is processed with 2 wt.-% aqueous NaOH (having a pH of about 13.7) at a weight ratio (flow rate ratio by wt.) of aqueous NaOH to LWP of 0.4, and assuming full removal of chlorine as NaCl, the calculated pH would decrease only down to 13.2. Such a pH shift is not problematic. However, the LWP feedstock may contain additional acidic substances, in particular organic acids originating from oxygen-containing waste plastics (e.g. PET) being subjected to liquefaction. In this case, the presence of organic acids may result in further decrease of pH down to pH 7 or even less upon reaction in the HT processing. Such a large pH decrease results in a significantly negative effect on HT processing efficiency, e.g. by reducing Si removal efficiency. Furthermore, the thus neutralized aqueous phase may be difficult to be post-processed. For example, the efficiency of a membrane filtration for separating organic contaminants from the aqueous phase may be degraded if the pH is too high.

The presence of organic acids and other acidic substances and the problems occurring with the partial or full neutralisation of the alkaline aqueous solution in the HT processing have not been recognized or considered in the prior art.

The present invention provides a method involving adjustment of the added amount of basic substance in the form of an aqueous solution based on the water-oil ratio, i.e. the relative amounts of aqueous solution (“water”) and LWP feedstock (“oil”) in the HT processing, and on at least one property measured from the LWP feedstock. Specifically, the present invention is directed to a method for optimizing the amount of basic substance to be added (in the form of an aqueous solution) to the LWP feedstock. In particular, the quality of the LWP feedstock is determined by measuring at least one property of the LWP feedstock. The at least one property at least includes (reflects) the total acid number of the LWP feedstock. Based on this measurement result, the addition amount of the basic substance (relative to the LWP feedstock in consideration of the water-oil ratio) is adjusted (calculated and added) so that the pH level of the aqueous phase (which is obtained from phase separation after HT processing and comprises contaminated material) reaches a target pH level after all the acidic components in LWP, as determined by the total acid number, have been neutralized by the basic substance. Even in a continuous process (continuous flow process), such an adjustment is preferably carried out only when the feedstock composition changes or is expected to change (e.g. at the very beginning of the process or every time the feedstock source or batch is changed) and/or relatedly (e.g. in certain intervals).

The present invention thus provides a fast and efficient method for setting an appropriate amount of basic substance to be added into a HT processing step which allows efficient use of basic substance (no need to employ very high excess) with very simply means.

In an embodiment, the pH level of the aqueous phase is monitored (and/or the alkalinity of the aqueous phase is determined). Preferably, the addition amount of the basic substance is repeatedly readjusted to maintain the pH at the target pH level (or to reach the target pH level), e.g. if the pH level is/drops below the target level. This readjustment may be carried out repeatedly throughout the process and/or at least at the beginning of the process (or when the LWP feedstock is changed). The readjustment is thus suited to “fine tune” the addition amount of the basic substance.

In the context of the present invention, liquefied waste plastics (LWP) means a product effluent from liquefaction process comprising at least depolymerising waste plastics. LWP is thus a material which is obtainable by depolymerizing waste plastics. LWP may also be referred to as polymer waste-based oils.

The waste plastics may be derived from any source, such as (recycled or collected) consumer plastics, (recycled or collected) industrial plastics or (recycled or collected) end-life-tires (ELT). In particular, the term waste plastics refers to an organic polymer material which is no longer fit for its use or which has been disposed of for any other reason. Waste plastics may more specifically refer to end-life tires, collected consumer plastics (consumer plastics referring to any organic polymer material in consumer goods, even if not having “plastic” properties as such), collected industrial polymer waste. In the sense of the present invention, the term waste plastics or “polymer” in general does not encompass purely inorganic materials (which are otherwise sometimes referred to as inorganic polymers). Polymers in the waste plastics may be of natural and/or synthetic origin and may be based on renewable and/or fossil raw material.

The liquefaction process is typically carried out at elevated temperature, and preferably under non-oxidative conditions. The liquefaction process may be carried out at elevated pressure. The liquefaction process may be carried out in the presence of a catalyst. The effluent from the liquefaction process may be employed as the liquefied waste plastic feedstock as such or may be subjected to fractionation (or separation) to provide a fraction (or separated liquid) of the effluent as the liquefied waste plastic feedstock. For example, the LWP feedstock may be a hydrothermal liquefaction oil or a fraction thereof. Similarly, multiple fractionations may be carried out. In addition, two or more liquefaction process effluents and/or fractions thereof may be combined to give the LWP feedstock. These effluents and/or fractions may have the same or similar boiling range or may have different boiling ranges.

In addition to liquid (NTP) hydrocarbons, i.e. hydrocarbons being liquid at normal temperature and pressure (NTP; 20° C., 101.325 kPa absolute), typical product effluents from liquefaction processes comprise gaseous (NTP) hydrocarbons, and hydrocarbons that are waxy or solid at NTP but become liquids upon heating, for example upon heating to 80° C.

In the context of the present disclosure, depolymerizing waste plastic means decomposing or degrading the polymer backbones of the waste plastic, typically at least thermally, to the extent yielding polymer and/or oligomer species of smaller molecular weight compared to the starting waste plastic, but still comprising at least liquid (NTP) hydrocarbons. In other words, as used herein, the liquefied waste plastic does not cover plastics in liquid form obtained merely by melting or by dissolving into a solvent, as these do not involve sufficient cleavage of the polymer backbones, nor waste plastics depolymerized completely to the monomer-level and thus being of gaseous (NTP) form. Depolymerizing waste plastics may also involve cleavage of covalently bound heteroatoms such as O, S, and N from optionally present heteroatom-containing compounds.

Initially the waste plastics, or each waste plastics species in mixed waste plastics, to be subjected to liquefaction, is usually in solid state, typically having a melting point in the range of 100° C. or more as measured by DSC as described by Larsen et al. (“Determining the PE fraction in recycled PP”, Polymer testing, vol. 96, April 2021, 107058). However, the waste plastics, or each waste plastics species, may be melted before and/or during the depolymerisation.

Solid waste plastics may contain various further components such as additives, reinforcing materials, etc., including fillers, pigments, printing inks, flame retardants, stabilizers, antioxidants, plasticizers, lubricants, labels, metals, paper, cardboard, cellulosic fibres, fibre-glass, even sand or other dirt. Some of the further components may be removed, if so desired, from the solid waste plastics, from melted waste plastic, and/or from liquefied waste plastic using commonly known methods.

Preferably, the (solid) waste plastics to be subjected to the liquefaction process (depolymerisation), and thus being the base material of the LWP feedstock, has an oxygen content of 15 wt.-% or less, preferably 10 wt.-% or less, more preferably 5 wt.-% or less, of the total weight of the (solid) waste plastics. The oxygen content may be 0 wt.-% and may preferably be in the range of 0 wt.-% to 15 wt.-% or 0 wt.-% to 10 wt. %. Oxygen content in wt.-% can be determined by difference using the formula 100 wt.-%-(CHN content+ash content), wherein CHN content refers to combined content of carbon, hydrogen and nitrogen, as determined in accordance with ASTM D5291, and ash content refers to ash content as determined in accordance with ASTM D482/EN15403.

In the present disclosure, when reference is made to a standard, the latest revision available on Jan. 31, 2022 shall be meant, unless stated to the contrary. Furthermore, all embodiments (such as all preferred values and/or ranges within the embodiments) of the present invention may be combined with each other to give new (preferred) embodiments, unless explicitly specified otherwise or unless such a combination would result in a contradiction.

The LWP preferably comprises primarily hydrocarbons, typically more than 50 wt.-% based on the total weight of the LWP. Typically the LWP comprises two or more hydrocarbon species selected from paraffins, olefins, naphthenes and aromatics. The composition of the LWP may vary depending e.g. on the composition of the waste plastics, liquefaction process type and conditions, and any additional treatments. Further, the assortment of various species of waste plastics and impurities associated with collected waste may result in a presence of impurities including silicon, sulphur, nitrogen, halogens and oxygen related substances in various quantities in the LWP.

The LWP feedstock of the present invention is derived from (crude) LWP and may, for example, be crude LWP (i.e. the liquid fraction directly emerging from the liquefaction process), pre-purified LWP, or a fraction of one of the afore-mentioned.

Further, in the present invention, the term “pH” refers to the pH value of a solution measured at (or converted to a value corresponding to measurement at) 20° C. The pH can be measured in accordance with Finnish standard SFS 3021.

The term “mechanical filtration” (also referred to as macrofiltration) relates to filtration with a pore size of from 0.5 to 40 μm, preferably 1 to 20 μm, such as 2 to 20 μm. The term “reverse osmosis” refers to filtration with a membrane having small pore size such that it can separate at least water from organic components of certain size. Such membranes are commonly designated by their molecular weight cut-off (rejection size) rather than by pore size. For example, a membrane having a cut-off of 200 Dalton usually relates to filtration with a pore size of from 0,05 nanometres to 0,1 nanometres.

The term “amount of basic substance” which is “added” or “adjusted” or “readjusted” (and thus employed in the HT processing) refers to the total amount of the basic substance employed in the HT processing. The amount can be (re) adjusted by modifying the content (concentration) of the basic substance in the aqueous solution comprising the basic substance.

The present invention relates to a method comprising HT processing of a LWP feedstock together with a aqueous solution comprising a basic substance and is characterized by adjusting the addition amount of the basic substance based on determination of the quality of the LWP feedstock and optionally readjusting the addition amount of the basic substance e.g. based on the result of monitoring the pH level of the aqueous phase (obtained from phase separation after HT processing). The method of the present invention produces a treated LWP material (after heat treatment and phase separation).

Specifically, the present invention relates to a method comprising providing a liquefied waste plastic (LWP) feedstock for heat treatment (HT processing) with an aqueous solution containing a basic substance, determining the quality of the LWP feedstock by measuring at least one property of the LWP feedstock, calculating an amount of the basic substance that needs to be added in HT processing to reach a target pH level of the aqueous phase based on the at least one property of the LWP feedstock and the water-oil-ratio, and subjecting the LWP feedstock to the heat treatment with the aqueous solution containing the calculated amount of basic substance in the form of aqueous solution, followed by phase separation to result in at least a treated LWP material and an aqueous phase. Specifically, phase separation results in an oil phase (comprising treated LWP) and an aqueous phase.

The quality of the LWP feedstock is determined by measuring at least one property of the LWP feedstock. The at least one property includes at least the total acid number (TAN) of the LWP feedstock. This single value can be determined quite easily and already provides high accuracy for predicting the amount of basic substance which is required to maintain (or adjust) the pH of the aqueous phase (i.e. after heat treatment and subsequent phase separation) at a target level. The TAN can be determined e.g. according to method ASTM D664.

The at least one property is preferably measured from the LWP feedstock after providing the LWP feedstock, which allows simple integration of the measurement.

The amount of basic substance to be added to the LWP feedstock can be easily calculated based on the TAN of the LWP feedstock. The TAN itself describes how much of a particular basic substance (KOH) is needed to neutralize all the acids that present in a given oil sample. If one would contact LWP with an aqueous solution that contains a stoichiometric amount of KOH for the neutralization of acids, then the resulting pH value of the solution is expected to be 7. However, if the target is to have a pH value of e.g. 10 (or more), then a higher amount of basic substance is needed. Accordingly, the target pH is taken into account when calculating the amount of basic substance that is needed. In addition the water-oil ratio is taken into account because the pH of the aqueous phase (after phase separation) of course depends on both the amount of water and the amount of non-neutralized basic substance.

The at least one property may comprise both the total acid number (TAN) and the total chlorine content of the LWP feedstock. The amount of basic substance to be added can be even more accurate when it is based on both of these properties. In the case of chlorine, one may base the calculation on the assumption that all of the chlorine that is present in LWP will be released in the form of hydrogen chloride (HCI) during HT processing. The released HCI will subsequently react with the basic substance, thus decreasing the pH value. The total chlorine content may be determined e.g. according to method ASTM

D7359.

In addition, the method of the present invention may comprise repeatedly (re) adjusting the addition amount of the basic substance. The readjustment may be based on the result of monitoring (e.g. based on a pH measurement result) the pH of the aqueous phase and/or based on the result of determining the alkalinity of the aqueous phase. Thus, possible inaccuracies in the determination (calculation) of the addition amount based on only the LWP quality can be compensated. However, since the determination based on only the LWP quality is already quite accurate, only minor readjustment is necessary and, therefore, the efficiency of the HT processing can be maintained at close-to-optimum throughout the process.

The method preferably comprises monitoring the pH of the aqueous phase (obtained from phase separation), e.g. (repeatedly) measuring the pH thereof.

Measurement of the pH of the aqueous phase (which may also be referred to as separated aqueous phase or as contaminated aqueous material) is easy to implement. Measurement can be carried out continuously or non-continuously (e.g. batch-wise from samples taken from the aqueous phase).

The measurement of the pH is preferably carried out directly after the phase separation. In this respect, “directly after” means that no further process (or workup) is provided in-between-it does not necessarily mean “immediately after” (or soon after) the phase separation.

Monitoring the pH can be accomplished by simple and fast measurement. Based on the measured pH (based on the monitoring result), the addition amount of the basic substance can be easily (re)adjusted. For example, if the pH is below the target pH level, the amount of basic substance is increased. Tabulated values or calculated values may for example be used for determining the necessary adjustment.

In addition (or alternatively) to monitoring the pH of the aqueous phase, the alkalinity of the aqueous phase may be (repeatedly) determined and used as a (further) basis for (re) adjusting the addition amount of the basic substance (for reaching/maintaining the target pH of the aqueous phase). Alkalinity is a measure for resisting acid addition and may be determined by titration. Thus, in this embodiment, if the alkalinity is too low, too much of the basic substance has been consumed and more is added in the course of readjustment, i.e. the amount is adjusted to higher amounts (in the next batch or in the continuous process). Alkalinity can be determined easily by titration, which may be favourable because titration is very robust versus (e.g. organic) impurities and/or contaminants in the aqueous phase (obtained from phase separation).

In the method of the present invention, the target pH level is preferably 10.0 or more. With this minimum target pH level, good HT processing efficiency can be ensured. Although the HT processing efficiency is high as long as the target pH (and more preferably the actual pH of the aqueous phase) is 10.0 or more, it is favourable to avoid excessive addition of basic substance in order to make efficient use of the basic substance, even though there is no actual upper limit of the target pH. In view thereof, the target pH level (and preferably the actual pH level) is preferably in the range of from 10.0 to 14.0, such as 10.2 to 13.9, 10.3 to 13.8, 10.4 to 13.6, 10.5 to 13.5, 10.6 to 13.4, 10.7 to 13.3, 10.8 to 13.2, 10.9 to 13.1, or 11.0 to 13.0. Nevertheless, using the method of the present invention, it is possible to set and even maintain the pH (almost completely) at a constant level and thus to provide well-defined conditions. Such well-defined conditions are not achievable with prior art approaches of simply adding an (estimated) excess of basic substance, which resulted in strong variations and thus non-uniform conditions.

The amount of the basic substance (added to the HT processing in the form of the aqueous solution) may be (re)adjusted by modifying the concentration of the basic substance in the aqueous solution employed in HT processing. Readjustment may comprise (re)calculating the (new/modified) addition amount and adding the calculated (modified) amount in HT processing. Adjusting the concentration of the basic substance in the aqueous solution can be accomplished easily, e.g. by admixing different amounts of a highly concentrated aqueous solution comprising the basic substance (stock solution) with other aqueous feed(s), such as fresh water and/or recycled water. The mixing may be accomplished before HT processing or in the course of HT processing (e.g. by co-feeding the stock solution and the other aqueous feed(s)).

The method of the invention may further comprise subjecting the aqueous phase to a workup comprising at least membrane filtration (reverse osmosis). The membrane filtration provides a TOC (total organic carbon) depleted permeate and a TOC enriched retentate. The inventors surprisingly found that an aqueous phase having a high pH shows a good responsiveness to membrane filtration. That is, with such an aqueous phase, good filtration efficiency can be achieved. In the present invention, the reverse osmosis membrane preferably has a cut-off in the range of from 50 to 400 Dalton, preferably 100 to 300 Dalton, such as 150 to 250 Dalton. The workup may further comprise mechanical filtration. Mechanical filtration may particularly be carried out before membrane filtration and then allows to prolong service life of the membrane (e.g. by protecting it from coarse impurities and/or by preventing fast clogging).

The method may further comprise recycling (at least a part of) the TOC depleted permeate back to the HT processing (e.g. as a part of the aqueous solution employed in HT processing). Thus, it is possible to re-use basic substance (e.g. NaOH) which was not been consumed in the HT processing. Moreover, it is possible to reduce the necessity of fresh water addition.

The LWP feedstock employed in the present invention may for example have a total acid number (TAN) of 0.1 to 100.0 mgKOH/g, such as 0.2 to 95.0 mgKOH/g, 0.3 to 90 mg KOH/g or more; 1.0 to 80 mg KOH/g, 3.0 to 60 mg KOH/g, 5.0 to 50.0 mg KOH/g, 7.0 to 30.0 mg KOH/g, or 9.0 to 20.0 mg KOH/g. The method of the present invention is particularly useful for LWP having a broad range of TAN values and even for a continuous process employing LWP feedstocks which vary in TAN values.

The LWP feedstock is preferably crude liquefied waste plastics or a fraction thereof. For example, the LWP feedstock has an initial boiling point of 50° C. or less, such as an initial boiling point (ASTM D86) in the range of 15° C. to 50° C., 20° C. to 45° C., or 25° C. to 40° C. and/or a final boiling point (ASTM D86) of 400° C. or more, such as in the range of from 400° C. to 700° C., 450° C. to 650° C., 500° C. to 650° C., or 550° C. to 650° C. The method of the present invention is particularly suited for such a LWP feed which has hardly undergone pre-purification, such as fractionation.

The basic substance contained in the aqueous solution employed in HT processing is preferably selected from the group consisting of alkali metal hydroxides and alkaline earth metal hydroxides. These hydroxides are strong bases and thus allow simple adjustment of the addition amount and good control of target pH level. Specifically, the basic substance is preferably selected from the group consisting of KOH, NaOH, LiOH, Ca(OH)₂, Mg(OH)₂, RbOH, Sr(OH)₂ and Ba(OH)₂. The basic substance may in particular be NaOH, since this is a strong base which is readily available.

The LWP feedstock may have an olefins content of 5 wt.-% or more, such as 10 wt.-% or more, 15 wt.-% or more, 20 wt.-% or more, 30 wt.-% or more, 40 wt.-% or more, or 50 wt.-% or more. The olefins content may for example be 85 wt.-% or less, 80 wt.-% or less, 70 wt.-% or less, or 65 wt.-% or less.

The aqueous solution preferably comprises at least 50 wt.-% water, preferably at least 70 wt.-% water, more preferably at least 85 wt.-% water or at least 90 wt.-% water. Containing mainly water makes the process easier to implement.

The aqueous solution preferably comprises at least 0.3 wt.-% of the basic substance, more preferably at least 0.5 wt.-%, at least 1.0 wt.-%, or at least 1.5 wt.-% of the basic substance. Although not particularly limited, the content of the basic substance is preferably 10.0 wt.-% or less, such as 6.0 wt.-% or less or 4.0 wt.-% or less.

In an embodiment, the aqueous solution comprises at least 0.5 wt.-%, preferably at least 1.0 wt.-%, or at least 1.5 wt.-% of a metal hydroxide or of an alkali metal hydroxide as the basic substance. Although not particularly limited, the content is preferably 10.0 wt.-% or less, such as 6.0 wt.-% or less or 4.0 wt.-% or less.

The HT processing is preferably carried out at a temperature of 150° C. or more, preferably 190° C. or more, such as 200° C. or more, 220° C. or more, 240° C. or more or 260° C. or more. The HT processing is preferably carried out at a temperature of 450° C. or less, preferably 400° C. or less, 350° C. or less, or 300° C. or less. For example, the HT processing is carried out at a temperature in the range of 200° C. to 350° C., preferably 220° C. to 330° C., 240° C. to 320° C., or 260° C. to 300° C. Such high temperature during HT processing, together with high pH, improves impurity removal efficiency since it allows even removal of organic-bound impurities, such as organic chlorine compounds or organic silicon compounds.

The chlorine content of the LWP feedstock may be in the range of from 1 wt.-ppm to 4000 wt.-ppm, such as 100 wt.-ppm to 4000 wt.-ppm, or 300 wt.-ppm to 4000 wt.-ppm. That is, the method of the present invention is suited to process a LWP feedstock having a broad concentration range of chlorine impurities.

The LWP feedstock may be a fraction of liquefied waste plastics or crude liquefied waste plastics. In particular, the LWP feedstock may have a 5% boiling point of 25° C., preferably 30° C. or more, 35° C. or more, such as in the range of from 25° C. to 120° C., in the range of from 25° C. to 100° C., in the range of 30° C. to 90° C., or in the range of from 35° C. to 80° C. The liquefied waste plastics (LWP) feedstock may have a 95% boiling point of 700° C. or less, preferably 650° C. or less, 600° C. or less, or 550° C. or less, such as in the range of from 180° C. to 700° C., 250° C. to 700° C., 300° C. to 650° C., 350° C. to 600° C., 380° C. to 500° C., or 400° C. to 500° C. The 5% and 95% boiling points of the LWP feedstock may be determined in accordance with ASTM D2887-16.

The step of providing the LWP feedstock may include a step of liquefying waste plastics, preferably by thermal degradation of waste plastics, such as pyrolysis or hydrothermal liquefaction or similar process steps. The liquefying may be carried out by any known method such as pyrolysis, including fast pyrolysis, hydropyrolysis and hydrothermal liquefaction.

The step of providing the LWP feedstock may include a step of liquefying sorted waste plastics, wherein the method further comprises a step of sorting waste plastics to provide the sorted waste plastics. In this step of sorting waste plastic, preferably at least 50 wt.-%, more preferably at least 55 wt.-%, at least 60 wt.-%, at least 65 wt.-%, at least 70 wt.-%, at least 75 wt.-%, at least 80 wt.-%, or at least 85 wt.-% of chlorine-containing waste plastics, such as polyvinyl chloride, PVC (relative to the original content of chlorine-containing waste plastic, such as PVC, in the waste plastics) are removed from the waste plastics.

The LWP feedstock preferably has a density, as measured at 15° C., in the range of from 0.780 to 0.950 kg/l (kg/dm³), such as in the range of from 0.780 to 0.900 kg/l, or in the range of from 0.780 to 0.850 kg/l.

Preferably, no hydrogen is added in the HT processing and/or no hydrotreating catalyst is present. That is, although hydrotreatment, in particular hydrogenation, can be favourable, such a procedure is less sustainable because of significant hydrogen gas consumption which is usually produced from fossil sources and/or with significant amounts of energy. More preferably, no hydrogen gas (including dissolved hydrogen gas) is present during the HT processing. In other words, the HT processing is preferably a simple process of heat treating the LWP feedstock together with the aqueous solution at elevated temperature.

In the present invention, it is preferable that the ratio between the bromine number (BN2) of the treated LWP material and the bromine number (BN1) of the LWP feedstock, BN2/BN1 is 0.90 or more, preferably 0.95 or more, such as in the range of from 0.90 to 1.10, 0.90 to 1.02, or 0.95 to 1.00. In the present invention, the bromine number can be determined in accordance with ASTM D1159-07 (2017).

The mixing ratio between the aqueous solution and the LWP feedstock (water-oil-ratio) in the heat treatment step is preferably in the range of from 0.1 to 1.4 by weight, preferably in the range of 0.2 to 1.0, such as 0.2 to 0.7. Within these mixing ratios, efficient processing can be assured, i.e. providing good purification without excessively producing waste water. In this respect, the mixing ratio “by weight” (wt/wt) means total weight of aqueous solution divided by total weight of LWP feedstock. In a continuous process the mixing ratio refers to the flow ratio (by weight) of the respective compositions.

### EXAMPLES

The present invention is illustrated by way of examples to better help understanding the invention. Although the Examples provide embodiments of the invention, the Examples shall not be used to narrow down the interpretation of the claims.

### Example 1

Simulated titration of three LWP feedstocks having varying total acid number (TAN) was carried out under the assumption that the LWP feedstocks are subjected to HT processing together with a NaOH aqueous solution having varying concentration, as shown in Table 1, at a mixing ratio aqueous solution/LWP feedstock ratio (water-oil-ratio) of 0.67 (by weight) and assuming full reaction of all components contributing to TAN. Table 1 shows the calculated resulting pH of the aqueous phase (after phase separation).

TABLE 1

| NaOH | TAN = 5 mg | TAN = 10 mg | TAN = 15 mg |
|---|---|---|---|
| (wt-%) | KOH/g | KOH/g | KOH/g |
| 0.1 | <7 | <7 | <7 |
| 0.2 | <7 | <7 | <7 |
| 0.3 | <7 | <7 | <7 |
| 0.4 | <7 | <7 | <7 |
| 0.5 | <7 | <7 | <7 |
| 0.6 | 12.3 | <7 | <7 |
| 0.7 | 12.6 | <7 | <7 |
| 0.8 | 12.8 | <7 | <7 |
| 0.9 | 13.0 | <7 | <7 |
| 1.0 | 13.1 | <7 | <7 |
| 1.1 | 13.2 | 12.1 | <7 |
| 1.2 | 13.2 | 12.6 | <7 |
| 1.3 | 13.3 | 12.8 | <7 |
| 1.4 | 13.3 | 12.9 | <7 |
| 1.5 | 13.4 | 13.1 | <7 |
| 1.6 | 13.4 | 13.1 | 11.9 |
| 1.7 | 13.5 | 13.2 | 12.5 |
| 1.8 | 13.5 | 13.3 | 12.8 |
| 1.9 | 13.5 | 13.3 | 12.9 |
| 2.0 | 13.6 | 13.4 | 13.0 |

In Table 1, “<7” denotes that the (simulated) pH drops below pH 7.

It can be seen that a pH level of e.g. 12.8 can be maintained by varying the NaOH concentration depending on the feed TAN, i.e. employing a 0.8 wt.-% aqueous solution for a LWP feedstock having a TAN of 5 mg KOH/g, employing a (slightly below) 1.3 wt.-% aqueous solution for a LWP feedstock having a TAN of 10 mg KOH/g, and employing a 1.8 wt.-% aqueous solution for a LWP feedstock having a TAN of 15 mg KOH/g. Accordingly, even in a process employing varying feeds, the pH conditions can be kept rather constant.

### Example 2

In order to demonstrate the influence of the pH level of the aqueous phase on the silicon removal efficiency, small scale experiments were carried out with a LWP feedstock containing 37 wt.-ppm Si and having a TAN of 15 mg KOH/g, under conditions of 240° C. (pyrolysis temperature) and a ratio between aqueous solution and LWP feedstock (water-oil-ratio) of 0.67 by weight. The basic substance that was used in these experiments was sodium hydroxide (NaOH).

The initial NaOH concentration (of the aqueous solution containing the basic substance) was set as 2 wt.-%. By taking into account the TAN of the LWP feedstock, the water-to-oil ratio and the NaOH concentration, it was calculated that the pH value of the aqueous phase after phase separation would be approximately 13. However, the experimentally obtained pH value was 8.6. The treated LWP material still contained some residual acidity (TAN 1.0 mg KOH/g) and silicon removal efficiency was 35%. It was found that a certain degree of silicon removal was obtained based on calculating the needed amount of the basic substance.

In another test, the basic substance (NaOH) concentration was readjusted to 3 wt-% and the test was repeated with a fresh LWP feed sample. By taking into account only the TAN of the LWP feedstock, the water-to-oil ratio and the NaOH concentration, it was calculated that the pH value of aqueous phase after phase separation would be approximately 13.5. After readjustment of the basic substance concentration, the experimentally obtained pH value of the aqueous phase after phase separation was 11.8. The treated LWP material no longer contained any residual acidity (TAN<0.1 mg KOH/g) and silicon removal was 90%. Thus, it was surprisingly found that the silicon removal efficiency was significantly improved with higher pH level of the aqueous phase.

### Comparative Example 1

For comparison, a fresh LWP feedstock sample (same as in Example 2) was treated with NaOH solution containing 1 wt.-% of NaOH under otherwise identical conditions (but disregarding the TAN when setting the NaOH addition amount). By taking into account the TAN of the LWP feedstock, the water-to-oil ratio and the NaOH concentration, it was calculated that all of the NaOH would be neutralized and that the pH value of the aqueous phase after phase separation would be less than 7. The experimentally obtained pH value was 5.3. The treated LWP material still contained significant residual acidity (TAN 7.7 mg KOH/g) and silicon removal efficiency was 0%. Thus, by choosing a basic substance concentration that will theoretically result in a neutral or acidic solution after HT processing and phase separation, it has been found that no silicon removal could be obtained.

Based on the findings above, it was unexpectedly found that, in order to have an acceptable level of silicon removal efficiency of the LWP in a heat treatment in a large scale operation, the preferred (target) pH level of the aqueous phase after phase separation would be at least 10 or above.

1-15. (canceled)

16. A method, comprising:
providing a liquefied waste plastic (LWP) feedstock for heat treatment (HT processing) with an aqueous solution containing a basic substance;
subjecting the LWP feedstock to the heat treatment with the aqueous solution, followed by phase separation to result in at least a treated LWP material and an aqueous phase;
determining a quality of the LWP feedstock by measuring at least one property of the LWP feedstock, the at least one property including at least the total acid number (TAN) of the LWP feedstock; and
calculating an amount of the basic substance to be added in the HT processing to reach a target pH level of the aqueous phase based on the at least one property of the LWP feedstock and a water-oil-ratio, and adding the calculated amount of basic substance formed as the aqueous solution to be in contact with the LWP feedstock.

17. The method according to claim 16, wherein the target pH level is pH 10.0 or more.

18. The method according to claim 16, comprising:
repeatedly readjusting the amount of the basic substance as the aqueous solution to reach the target pH level of the aqueous phase.

19. The method according to claim 16, wherein the at least one property of the LWP feedstock includes both the total acid number (TAN) and a total chlorine content of the LWP feedstock.

20. The method according claim 16, comprising:
adjusting the amount of the basic substance by modifying a concentration of the basic substance in the aqueous solution employed in the HT processing.

21. The method according to claim 1, wherein the LWP feedstock has a total acid number (TAN) in a range of 0.1 to 100.0 mgKOH/g, and/or 0.2 to 95.0 mgKOH/g, 0.3 to 90 mg KOH/g or more; 1.0 to 80 mg KOH/g, 3.0 to 60 mg KOH/g, 5.0 to 50.0 mg KOH/g, 7.0 to 30.0 mg KOH/g, and/or 9.0 to 20.0 mg KOH/g.

22. The method according to claim 16, wherein the basic substance is selected from the group consisting of:
alkali metal hydroxides and alkaline earth metal hydroxides, and/or the basic substance is selected from the group consisting of:
KOH, NaOH, LiOH, Ca(OH)₂, Mg(OH)₂, RbOH, Sr(OH)₂ and Ba(OH)₂, and NaOH.

23. The method according to claim 16, wherein the aqueous solution comprises:
at least 50 wt.-% water, and/or at least 70 wt.-% water, and/or at least 85 wt.-% water, at least 90 wt.-% water and/or at least 95 wt.-% water.

24. The method according to claim 16, wherein the aqueous solution comprises:
at least 0.3 wt.-% of the basic substance, and/or at least 0.5 wt.-%, at least 1.0 wt.-%, or at least 1.5 wt.-% of the basic substance, and/or 0.5 wt.-% to 10.0 wt.-%, 1.0 wt.-% to 6.0 wt.-%, and/or 1.5 w.-% to 4.0 wt.-%.

25. The method according to claim 16, comprising:
monitoring a pH level of the aqueous phase obtained from phase separation.

26. The method according to claim 16, wherein the liquefied waste plastics (LWP) feedstock has a 5% boiling point of 25° C. or more, and/or 30° C. or more, and/or 35° C. or more, and/or in a range of from 25° C. to 120° C., in a range of from 25° C. to 100° C., in a range of 30° C. to 90° C., and/or in a range of from 35° C. to 80° C.

27. The method according to claim 16, wherein the liquefied waste plastics (LWP) feedstock has a 95% boiling point of 700° C. or less, and/or 650° C. or less, 600° C. or less, and/or 550° C. or less, and/or in a range of from 180° C. to 700° C., 250° C. to 700° C., 300° C. to 650° C., 350° C. to 600° C., 380° C. to 500° C., and/or 400° C. to 500° C.

28. The method according to claim 16, wherein the LWP feedstock has a density, as measured at 15° C. in a range of from 0.780 to 0.950 kg/l, and/or in a range of from 0.780 to 0.900 kg/l, and/or in a range of from 0.780 to 0.850 kg/l.

29. The method according to claim 16, comprising:
carrying out the HT processing at a temperature of 150° C. or more, 190° C. or more, 200° C. or more, 210° C. or more, 220° C. or more, 240° C. or more, and/or 260° C. or more.

30. The method according to claim 16, wherein a mixing ratio (water-oil-ratio) between the aqueous solution and the LWP feedstock in the heat treatment is in a range of from 0.1 to 1.4 by weight, and/or in a range of 0.2 to 1.0, and/or 0.2 to 0.7.
